(19) United States
(12) Patent Application Publication
(10) Pub. No.: US 2026/0017512 A1
(43) Pub. Date: Jan. 15, 2026

(54) Object Classification Based on Measurement Data From a Plurality of Perspectives Using Pseudo-Labels

(71) Applicant: Robert Bosch GmbH, Stuttgart (DE)

(72) Inventors: Beke Junge, Hildesheim (DE); Fabian Gigengack, Hemmingen (DE); Azhar Sultan, Tunbridge Wells (GB)

(21) Appl. No.: 18/880,505

(22) PCT Filed: Jul. 11, 2023
(86) PCT No.: PCT/EP2023/069168

§ 371 Date: Dec. 31, 2024

(30) Foreign Application Priority Data
Jul. 12, 2022 (DE) 10 2022 207 091.7

(51) Int. Cl. G06N 3/08

(52) U.S. Cl. CPC G06N 3/08

(57) ABSTRACT

A method for training one or more neural networks for processing measurement data includes providing training examples for the measurement data including both training examples labeled with target classification scores and unlabeled training examples, and processing the training examples by the one or more neural networks into classification scores. The method further includes, with respect to the labeled training examples, using a specified cost function to evaluate to what extent (i) the classification scores correspond to the respective target classification scores, and (ii) intermediate products formed from similar training examples are similar to each other while intermediate products formed from dissimilar training examples are dissimilar to each other. The method further includes optimizing parameters characterizing a behavior of the one or more neural networks with the goal that an assessment by the cost function is expected to improve during further processing of the training examples.

The present invention relates to training neural networks to detect and classify objects using measurement data recorded from different perspectives and/or by means of different measurement modalities. Iteratively generated pseudo-labels are used to improve training quality.

### PRIOR ART

In order to at least partially automatedly drive a vehicle in traffic, a representation of the environment of the vehicle also indicating the objects located in said environment is required. Thus, the environment of the vehicle is typically monitored by means of a plurality of cameras and/or other sensors, such as radar sensors or lidar sensors. The respective measurement data obtained is then evaluated by means of neural classification networks to determine which objects are present in the environment of the vehicle.

US 2021/012 166 A1, WO 2020/061 489 A1, U.S. Pat. No. 10,762,359 B2, and JP 6 614 611 B2 disclose training such neural networks by means of a “contrastive loss.” For example, the neural networks may be tuned to each other in that said networks map images showing the same objects to the same representations. However, this does not yet relieve the obligation to provide sufficient labeled training examples for each camera perspective.

### DISCLOSURE OF THE INVENTION

The invention provides a method for training one or more neural networks. Said networks are specifically neural networks for processing the measurement data, particularly images recorded from different perspectives and/or by means of different measurement modalities, into classification scores with respect to one or more classes of a specified classification. The classes may relate in particular, for example, to various types of objects present in a region sensed by recording the measurement data.

The method begins with providing training examples for measurement data. Said training examples comprise both training examples labeled by means of target classification scores and unlabeled training examples.

The training examples are processed into classification scores by the one or more neural networks. In this context, an intermediate product is also captured, from which the classification scores are formed. Said intermediate product may in particular be, for example, a representation of the measurement data having a significantly lower dimensionality than the measurement data itself, but still a higher dimensionality than the classification scores ultimately determined.

The classification scores may take on continuous values. However, a preferred class also follows from said continuous values according to a specified rule. For example, the class for which the classification score is highest may be assessed as a preferred class.

A specified cost function (loss function) is then used with respect to the labeled training examples to evaluate to what extent
the classification scores correspond to the respective target classification scores, and
intermediate products formed from similar training examples are similar to one another, while at the same time intermediate products formed from dissimilar training examples are dissimilar to one another.

Here, the similarity of training examples to any arbitrary metric may be measured. For example, a similarity or equality of target classification scores may also be incorporated into said metric.

For this purpose, the cost function may, in particular, comprise a classification loss measuring conformance to the target classification scores and a contrastive loss measuring the similarity of the intermediate products.

Parameters characterizing the behavior of the one or more neural networks are optimized with the goal that the assessment by the cost function is expected to improve during further processing of training examples. For example, the value of the loss function may be propagated back to gradients along which the individual parameters are to be changed in the next learning step. For example, in the one or more neural networks, there may be a division of labor such that a particular portion of the architecture forms the intermediate product and another portion of the architecture determines the classification scores from the intermediate product. Then, the contrastive loss acts primarily on the part forming the intermediate product and the classification loss acts primarily on the part determining the classification scores.

A test is then performed as to what extent there are subsets of the training examples for which the following applies:
the subset comprises at least one unlabeled training example;
the intermediate products formed from the training examples of the subset are similar to one another according to a specified criterion.

In addition, it can optionally be tested whether said intermediate products
are mapped to classification scores indicative of at least the same preferred class when further processed in the one or more neural networks, and/or
are mapped to classification scores considered to be semantically similar due to a specified fusion strategy.

For example, if representations of three successive images in a video stream are similar to one another, but are mapped to different preferred classes (such as “cars” twice and “light trucks” once), a majority decision may be made. Also, for example, sedans and cabriolets classified into different classes may be considered similar to one another because both are members of the parent class “cars.” This will depend on the application at hand.

Training examples failing said test may still be used to continue training for the contrastive loss. Such example therefore need not be completely discarded.

In this case, spatial and/or temporal filtering and other pre-processing may optionally still be carried out. For example, triangulation, odometry, simultaneous location and mapping (SLAM), or other known algorithms may be used to suggest objects that may have been seen from multiple perspectives. Also, in reference to a manual annotation of such an object, said object may be used to compare the classification scores and intermediate products determined from various training examples with each other. The comparison therefore need not relate to the entire image content, for example, but may be focused on relevant objects.

Provided there are unlabeled training examples having the same preferred classes and similar intermediate products, the unlabeled training examples of the subset having said preferred class as the label (“pseudo-label”) are transferred to the labeled training examples. The one or more neural networks are then trained on the training examples upgraded in this manner. The present method may be continued iteratively until a specified termination condition is satisfied. For example, the termination condition may comprise that there are no appreciable gains from iteration to iteration in new training examples provided with “pseudo-labels.”

Thus, for example, if a plurality of neural networks processing training examples recorded from different perspectives are in agreement that said training examples indicate the presence of an object of the class “vehicle,” and if at the same time the intermediate products produced from said training examples are sufficiently similar, then the probability is high that said training examples actually indicate the presence of a vehicle. The originally unlabeled training examples may then then be used as training examples for the “vehicle” class.

For example, if an overtaking foreign vehicle is observed when monitoring the environment of a vehicle, said vehicle cannot be simultaneously in front of and behind the subject vehicle. Rather, the foreign vehicle will initially be visible behind, then next to, and finally in front of the subject vehicle, thereby switching between the detection ranges of different cameras each seeing the vehicle from different perspectives. By applying the aforementioned filtering and pre-processing, pseudo-labels can be obtained that are applicable to a comparable proportion as manually assigned labels.

When a vehicle travels around a curve and is observed by only one camera, said vehicle is seen by said one camera from a plurality of perspectives. A plurality of images of the vehicle can, in turn, be obtained from said multiple views, and said images are coupled to one another in a particular manner, i.e. should not conflict with one another.

By means of said training procedure, starting from initially only a few training examples, the labeled portion of the training examples can be iteratively further and further increased. The one or more neural networks may then be used immediately after completion of the training for classifying further unseen measurement data. Regardless of this, however, the training examples, of which a larger proportion is now labeled than before, may also be used to train other neural networks.

This means significant cost savings for the overall training, because manual labeling of training examples is the greatest driver of the training cost.

In an advantageous embodiment, the cost function is used to assess, with respect to the unlabeled training examples, the extent to which intermediate products obtained from said training examples that are at least mapped to the same preferred class by the one or more neural networks are similar to each other. Then, the unlabeled training examples may also be used to train the one or more neural networks to form identical intermediate products for identical objects.

In a particularly advantageous embodiment, at least one neural network comprising a feature extractor and a classifier is selected. The training examples are supplied to the feature extractor. The output of the feature extractor is supplied to the classifier as an intermediate product. The contrastive loss may then substantially act on the parameters of the feature extractor and the classification loss may substantially act on the parameters of the classifier.

The feature extractor may, in particular, comprise a sequence of multiple fold layers, for example, each applying one or more filter cores in a specified grid to form a feature map of said input. The last feature map in a resulting sequence of feature maps has a significantly lower dimensionality than a training example, for example, but at the same time still a significantly greater dimensionality than the classification scores ultimately output.

The classifier may, in particular, include at least one fully connected layer, for example. For example, such a layer may compress a feature map to a vector of classification scores with respect to the available classes.

For the training by means of the enhanced training examples, the parameters of the one or more neural networks may be reinitialized in one embodiment. The advantage of the present embodiment is that the new training is then based from the outset on an extensive set of labeled training examples and is free of aberrations that may have come into the parameters from the previous training by means of only a small proportion of labeled training examples. The price for this is that the computational time invested in the previous training is also discarded.

Thus, in an alternative embodiment, the training by means of the enhanced training examples builds on the existing state of the parameters of the one or more neural networks. The present embodiment is particularly advantageous if the existing training examples are very numerous and/or very complex. For one thing, the computational effort that would be dismissed for a full restart of the training would be comparatively high. For another, a rich set of training examples allow for correcting any aberrations from the previous training.

In a further particularly advantageous embodiment, measurement data recorded from different perspectives and/or by means of different mapping modalities are fed to the one or more neural networks after the training records. Said records are typically measurement data that the one or more neural networks did not see in the previous training. However, this is not absolutely necessary. The term “record” is to be understood analogously to the English meaning thereof in connection with databases. A record corresponds to a single entry in the database potentially having particular attributes, comparable to a single index card in a card file. For example, a record may comprise an image, a radar scan, or a lidar scan. The German term “data set” would also be applicable, but applies to the entirety of all records in the field of machine learning, comparable to the complete card file.

Through the training by means of “pseudo-labels” described above, a better ratio of classification accuracy to training effort can be achieved in active operation using records of measurement data unseen in the training than in a training in which exclusively manually labeled training examples are used. Manual labeling is the “Gold Standard” in terms of accuracy, but the effort is disproportionally greater than that of fully automated training by means of “pseudo labels.”

In a further advantageous embodiment, a similarity of intermediate products determined from different records of measurement data, where each of the preferred classes determined from said records also match, is considered an indicator that said records indicate the presence of the same object in one or more sensing ranges of one or more sensors. The intermediate product comprises significantly more information than the maximally compacted classification scores. In this way, for example, “ghost detections” of object instances, which are in fact not at all present, can be suppressed when a plurality of objects are detected from the measurement data.

In a further advantageous embodiment, the assessment that the records indicate the presence of the same object in one or more sensing ranges may additionally be made dependent upon a spatial and/or temporal relationship between the records satisfying a specified condition. In this way, for example, it can be taken into account that one and the same object cannot realistically be simultaneously at two locations that are far apart.

In a further advantageous embodiment, measurement data and/or training examples recorded by multiple sensors having non-identical spatial sensing regions are selected. For example, the environment of a vehicle may be monitored by means of a plurality of sensors having partially overlapping sensing ranges so that the environment is completely covered.

The measurement data or training examples may comprise, in particular, camera images, video images, thermal images, ultrasonic images, radar data, and/or lidar data. Especially when monitoring the environment of vehicles, more than one measurement modality is often used. It is very difficult to ensure that a single measurement modality works properly under all circumstances and in all traffic situations. For example, a camera may be overexcited by direct incident sunlight such that the display shows only a white area as an image. However, said interference does not act on a radar sensor operated simultaneously, by means of which at least limited observation is still possible. The training method proposed herein may very well instruct one or more neural networks to merge measurement data recorded by means of multiple measurement modalities into one detection of one or more objects.

In a further advantageous embodiment, an actuating signal is determined from the output of the one or more trained neural networks. Said actuating signal is used to control a vehicle, a driver assistance system, a quality control system, an area monitoring system, and/or a medical imaging system. This increases the probability that the response of the respective actuated system is appropriate to the situation embodied by the entered records of measurement data. In particular, the use of pseudo-labels during the training also contributes to said improved performance in the operation of the neural network. In particular, the probability that the actuated system will react to “ghost detections” of objects in the measurement data is reduced. For example, such “ghost detections” could cause an actuated vehicle to perform an automatic full braking without there being a factual (and visible to other road users) reason for this.

The method may in particular be completely or partially computer-implemented. The invention therefore also relates to a computer program having machine-readable instructions causing one or more computers and/or computer instances to perform the described method when executed on the one or more computers and/or computer instances. In this sense, control devices for vehicles and embedded systems for technical devices likewise capable of executing machine-readable instructions are also to be regarded as computers. For example, computer instances may be virtual machines, containers, or also serverless execution environments in which machine-readable instructions can be executed.

Likewise, the invention also relates to a machine-readable data storage medium and/or to a download product having the computer program. A download product is a digital product that can be transmitted via a data network, i.e., can be downloaded by a user of the data network, and can, for example, be offered for immediate download in an online shop.

Furthermore, a computer may be equipped with the computer program, with the machine-readable data storage medium, or with the download product.

Further measures improving the invention are described in greater detail hereinafter, together with the description of the preferred exemplary embodiments of the invention, with reference to the drawings.

### EXEMPLARY EMBODIMENTS

The figures show:

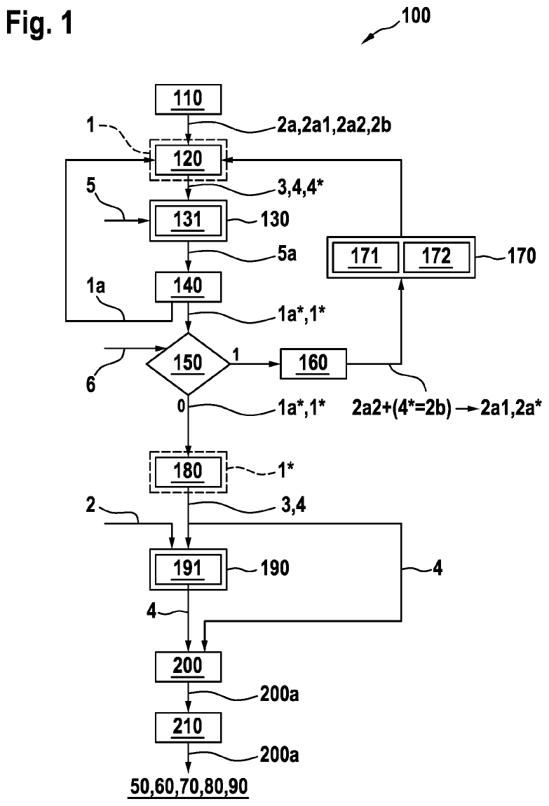

FIG. 1 exemplary embodiment of the method 100 for training one or more neural networks 1;

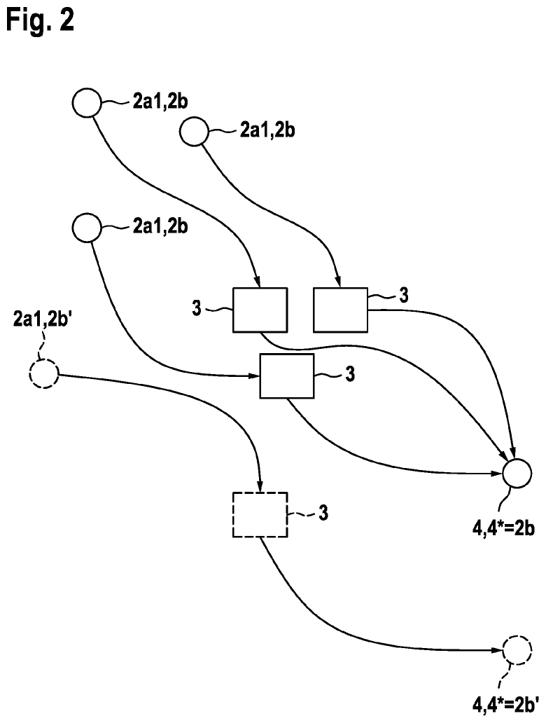

FIG. 2 Illustration of the training according to the method 100;

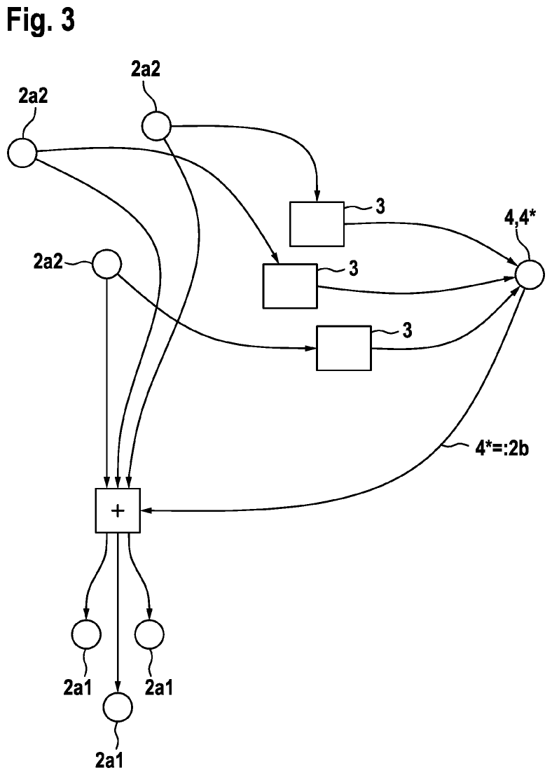

FIG. 3 Illustration of the extraction of pseudo-labels in the context of the method 100.

FIG. 1 is a schematic flow chart of an exemplary embodiment of the method 100 for training one or more neural networks 1. The one or more neural networks 1 process measurement data 2, particularly images recorded from different perspectives and/or by means of different measurement modalities, into classification scores 4 with respect to one or more classes of a specified classification.

In step 110, training examples 2a for measurement data 2 are provided. Said training examples 2a comprise both training examples 2a1 labeled with target classification scores 2b and unlabeled training examples 2a2.

In step 120, the training examples 2a are processed by the one or more neural networks 1 into classification scores 4. In the course of said processing, an intermediate product 3 is also captured, from which the classification scores 4 are formed.

In step 130, with respect to the labeled training examples 2a1, a specified cost function (loss function) 5 is evaluated as to what extent
the classification scores 4 correspond to the respective target classification scores 2b (classification loss), and
intermediate products 3 formed from training examples 2a1 having the same target classification scores 2b are similar to each other.

Optionally, according to block 131, with respect to the unlabeled training examples 2a2, it can be additionally assessed by means of the cost function 5 to what extent intermediate products 3 obtained from said training examples 2a2 and at least mapped to the same preferred class 4* by the one or more neural networks 1 are similar to one another. Training with respect to contrastive loss may thus also use the unlabeled training examples 2a2.

In step 140, parameters 1a characterizing the behavior of the one or more neural networks are optimized with the goal that the assessment 5a by the cost function 5 is expected to improve during further processing of training examples 2a1. The fully optimized state of the parameters la is designated by reference sign 1a*. Accordingly, the fully trained state of the one or more neural networks 1 is denoted by reference numeral 1*.

In step 150, it is checked whether the intermediate products 3 formed for a subset of the training examples 2a comprising at least one unlabeled training example 2a2 are similar to one another according to a specified criterion 6. As discussed above, it may optionally continue to be checked whether the intermediate products 3
are mapped to classification scores 4 indicating at least the same preferred class 4*, and/or
are mapped to classification scores 4 to be considered semantically similar due to a specified fusion strategy.

If the check is positive (truth value 1), in step 160 the unlabeled training examples 2a2 of the subset having said preferred 4* are transferred to the labeled training examples 2a1 as label 2b. Thus, a great many enhanced training examples 2a* will be obtained overall.

In step 170, the one or more neural networks 1 are trained by means of said upgraded training examples 2a*.

According to block 171, the parameters 1a of the one or more neural networks 1 may be reinitialized.

Alternatively, according to block 172, training by means of the enhanced training examples 2a* may be based on the existing state of the parameters 1a of the one or more neural networks 1.

In the example shown in FIG. 1, the termination condition for the iterations of the training is that in step 150 no further unlabeled training examples 2a2 able to be provided with new pseudo-labels can be found (truth value 0).

Following the training, records of measurement data 2 recorded from different perspectives and/or by means of different mapping modalities are fed to the one or more trained neural networks 1*.

Then, in step 190, a similarity of intermediate products 3 determined from different records of measurement data 2 may be evaluated as an indicator that said records indicate the presence of the same object in one or more sensing ranges of one or more sensors.

Here, according to block 191, the assessment that the records indicate the presence of the same object in one or more detection ranges may be additionally made dependent on a spatial and/or temporal relationship between the records satisfying a specified condition.

In step 200, an actuating signal 200a may be determined from the output 4 of the one or more trained neural networks 1*.

In step 210, said actuating signal 200a may then be used to actuate a vehicle 50, a driver assistance system 60, a quality control system 70, an area monitoring system 80, and/or a medical imaging system 90.

FIG. 2 illustrates the state sought by means of the training described above. In the example shown in FIG. 2, some training examples 2a1 are labeled with a target classification score 2b, as well as another training example 2a1 labeled with a different target classification score 2b′. For clarity, the similarity of the labeled training examples 2a1 in the example shown in FIG. 2 is measured in whether said labeled training examples 2a1 belong to the same target classes 2b.

The contribution of the classification loss to the cost function over the course of the training results in training examples 4a1 labeled with the target classification score 2b, such as a “one-hot” score for a particular class, also being mapped by the one or more neural networks 1 to precisely the same class 2b as the preferred class 4*. The contribution of the contrastive loss to the cost function 5 results in the intermediate products 3 produced along the way being close to each other.

In contrast, the training example 2a1 labeled with the target classification score 2b′ is also mapped to said class 2b′ as the preferred class 4*. Accordingly, the intermediate product 3 produced on the way here is also far removed from the other intermediate products 3.

FIG. 3 illustrates the obtaining of pseudo-labels. In the example shown in FIG. 3, three unlabeled training examples 2a2 are mapped to one and the same preferred class 4*. At the same time, the intermediate products 3 obtained in this case are close to one another, and thus are similar. In response to this, the preferred class 4* is defined as new pseudo-label 2b and associated with the aforementioned previously unlabeled training examples 2a2. Said training examples 2a2 thus become labeled training examples 2a1.

1. A method for training one or more neural networks for processing measurement data into classification scores with respect to one or more classes of a specified classification, the method comprising:
providing training examples for the measurement data comprising both (i) labeled training examples labeled with target classification scores, and (ii) unlabeled training examples;
processing the training examples by the one or more neural networks into classification scores, and capturing an intermediate product from which the classification scores are formed;
using, with respect to the labeled training examples, a specified cost function used to evaluate to what extent (i) the classification scores correspond to the respective target classification scores, and (ii) intermediate products formed from similar training examples are similar to each other while intermediate products formed from dissimilar training examples are dissimilar to each other;
optimizing parameters characterizing a behavior of the one or more neural networks with a goal that an assessment by the cost function is expected to improve during further processing of training examples;
checking whether the intermediate products formed for a subset of the training examples comprising at least one unlabeled training example are similar to each other according to a specified criterion;
when similar, transferring the unlabeled training examples of the subset having a preferred class as a label to the labeled training examples; and
training the one or more neural networks using the training examples upgraded in this manner.

2. The method according to claim 1, further comprising:
additionally checking whether the intermediate products formed from the subset of the training examples (i) are mapped to classification scores indicating at least the same preferred class, and/or (ii) mapped to classification scores considered to be semantically similar due to a specified fusion strategy.

3. The method according to claim 1, wherein with respect to the unlabeled training examples, the cost function is used to evaluate to what extent the intermediate products obtained from the training examples and at least mapped to the same preferred class by the neural networks are similar to one another.

4. The method according to claim 1, further comprising:
selecting at least one neural network comprising a feature extractor and a classifier is selected,
wherein the training examples are supplied to the feature extractor and an output of the feature extractor is supplied as an intermediate product to the classifier.

5. The method according to claim 4, wherein the feature extractor comprises a sequence of multiple fold layers each forming a feature map of an input by applying one or more filter cores to the input in a specified grid.

6. The method according to claim 4, wherein the classifier comprises at least one fully cross-linked layer.

7. The method according to claim 1, wherein for training using an enhanced training examples, the parameters of the one or more neural networks are reinitialized.

8. The method according to claim 1, wherein the training using enhanced training examples is based on a the present state of the parameters of the one or more neural networks.

9. The method according to claim 1, wherein the one or more trained neural networks are then provided with training records of measurement data recorded from different perspectives and/or by different mapping modalities.

10. The method according to claim 9, wherein a similarity of intermediate products determined from different records of measurement data is considered to be an indicator that said records indicate a presence of a the same object in one or more sensing ranges of one or more sensors.

11. The method according to claim 10, wherein the assessment that the records indicate the presence of the same object in one or more sensing ranges is additionally made dependent on a spatial and/or temporal relationship between the records satisfying a specified condition.

12. The method according to claim 1, further comprising:
selecting measurement data or training examples recorded by multiple sensors having non-identical spatial sensing regions.

13. The method according to claim 1, further comprising:
selecting measurement data or training examples comprising camera images, video images, thermal images, ultrasonic images, radar data, and/or lidar data.

14. The method according to claim 1, wherein:
an actuating signal is determined from an output of the one or more trained neural networks, and
a vehicle, a driving assistance system, a quality control system, an area monitoring system, and/or a medical imaging system is actuated based on the control signal.

15. A computer program comprising machine-readable instructions for causing one or more computers and/or computer instances to perform the method according to claim 1 when executed on one or more computers and/or computer instances.

16. A non-transitory machine-readable data storage medium comprising the computer program according to claim 15.

17. One or more computers having the computer program according to claim 15.
